(19) United States
(12) Patent Application Publication
(10) Pub. No.: US 2011/0099545 A1
(43) Pub. Date: Apr. 28, 2011

(54) METHOD AND APPARATUS FOR SIMULTANEOUSLY UPDATING SOFTWARE INSTALLED IN TERMINALS IN COMMUNICATION SYSTEM

(75) Inventors: Youngsuk LEE, Gwangju (KR); Dongsoo LEE, Gwangju (KR); Hark YOO, Gwangju (KR); Geun Yong KIM, Gyeonggi-do (KR); Sung Chang KIM, Gwangju (KR); Mun Seob LEE, Daejeon (KR)

(73) Assignee: Electronics and Telecommunications Research Institute, Daejeon (KR)

(21) Appl. No.: 12/652,812

(22) Filed: Jan. 6, 2010

(30) Foreign Application Priority Data
Oct. 27, 2009 (KR) 10-2009-0102230

(51) Int. Cl. G06F 9/44

(52) U.S. Cl. 717/172

(57) ABSTRACT

Provided is a method of controlling a server to simultaneously update software installed in a plurality of terminals in a communication system, the method including: receiving an update message from each of the terminals; determining a size of a transmission window based on the update message; processing an image of software to be transmitted to the plurality of terminals, based on the size of the transmission window; and transmitting the image of software to the plurality of terminals.

### CROSS-REFERENCE TO RELATED APPLICATION

This application claims the benefit of Korean Patent Application No. 10-2009-0102230, filed on Oct. 27, 2009, in the Korean Intellectual Property Office, the disclosure of which is incorporated herein by reference.

### BACKGROUND

1. Field of the Invention

The present invention relates to a method and apparatus for simultaneously updating software installed in a plurality of terminals, and more particularly, to a method and apparatus of setting, to a broadcast channel, a control channel included in a communication system, to thereby simultaneously update software installed in a plurality of terminals.

2. Description of the Related Art

A conventional communication system such as a telephone network, a mobile communication network, and a Gigabit-capable Passive Optical Network (GPON) may include a control channel and a data channel. The control channel enables a communication server of the communication system to be connected with a terminal in a one-to-one structure, to thereby manage information associated with the terminal and control the terminal. In particular, the GPON may update software installed in the corresponding terminal via the control channel using an optical network terminal (ONT) Management and Control Interface (OMCI).

In this instance, due to the structural characteristic that the communication server and the terminal are connected with each other in the one-to-one structure, when a plurality of terminals exists, a number of software update procedures corresponding to a number of the terminals may be needed to be performed to update software installed in the terminals. For example, when it takes about five minutes to update software installed in a single terminal, it may take about 50 minutes to update software installed in ten terminals.

Accordingly, there is a need for a method of quickly updating software installed in a plurality of terminals that may cope with Distributed Denial of Service (DDoS) attacks and the like.

### SUMMARY

An aspect of the present invention provides a method and apparatus for quickly updating software installed in a plurality of terminals between a communication server and the plurality of terminals.

According to an aspect of the present invention, there is provided a method of controlling a server to simultaneously update software installed in a plurality of terminals in a communication system, the method including: receiving an update message from each of the terminals; determining a size of a transmission window based on the update message; processing an image of software to be transmitted to the plurality of terminals, based on the size of the transmission window; and transmitting the image of software to the plurality of terminals.

According to another aspect of the present invention, there is provided a method of controlling a terminal to simultaneously update software installed in a plurality of terminals in a communication system, the method including: receiving a software update start message; and setting an update message based on the software update start message.

According to still another aspect of the present invention, there is provided a server to simultaneously update software installed in a plurality of terminals in a communication system, the server including: a message generator to generate at least one message of a software update start message that is transmitted to the plurality of terminals, and indicates a start of update with respect to the plurality of terminals, a message that is transmitted to the plurality of terminals, and indicates a size of a transmission window, a message that indicates an end of an image of software installed in the plurality of terminals, a software activation request message that is transmitted to the plurality of terminals for an application of the image of software, and a software image commit message that indicates a termination of updating with respect to the plurality of terminals; and a transmission window size decision unit to determine the size of the transmission window to be transmitted to the plurality of terminals.

According to yet another aspect of the present invention, there is provided a terminal to simultaneously update software installed in a plurality of terminals in a communication system, the terminal including: a transceiver to receive, from a server, a message including a software update start message, and to transmit an update message to the server; and an update message setting unit to set the update message based on the software update start message.

### EFFECT

According to embodiments of the present invention, it is possible to effectively perform update of software with respect to a plurality of terminals within a short period of time.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a control channel and a data channel in a communication system according to an embodiment of the present invention;

FIG. 2 is a diagram illustrating a format of an optical network terminal (ONT) Management and Control Interface (OMCI) packet in the communication system of FIG. 1;

FIG. 3 is a diagram illustrating an image of software transmitted from a server according to an embodiment of the present invention;

FIG. 4 is a diagram illustrating a process of performing a software update procedure in a one-to-one structure according to an embodiment of the present invention;

FIG. 5 is a diagram illustrating a process of performing a software update procedure in a one-to-many structure in order to simultaneously update software installed in a plurality of terminals in a communication system according to an embodiment of the present invention;

FIG. 6 is a flowchart illustrating a method of controlling a server to simultaneously update software installed in a plurality of terminals in a communication system according to an embodiment of the present invention;

FIG. 7 is a block diagram illustrating a configuration of a server to simultaneously update software installed in a plurality of terminals in a communication system according to an embodiment of the present invention; and

FIG. 8 is a block diagram illustrating a configuration of a terminal to simultaneously update software installed in a plurality of terminals in a communication system according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

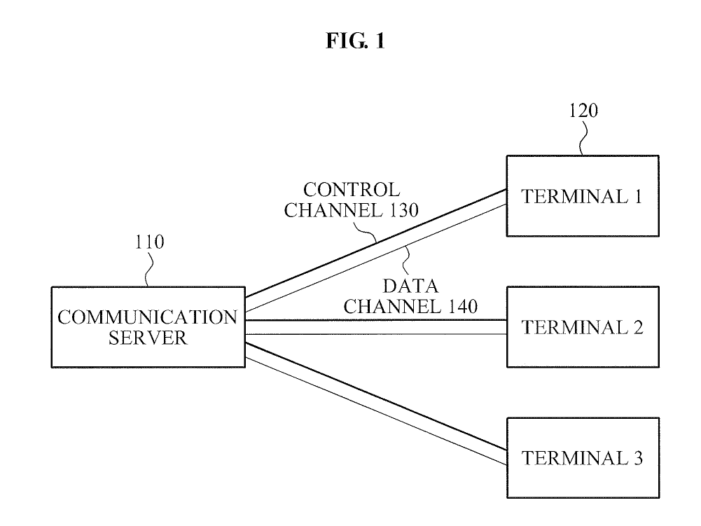

FIG. 1 is a diagram illustrating a control channel 130 and a data channel 140 in a communication system according to an embodiment of the present invention.

Referring to FIG. 1, in the communication system, a communication server 110 may transmit and receive a message to and from a plurality of terminals (terminal 1, terminal 2, and terminal 3) 120 using an optical network terminal (ONT) Management and Control Interface (OMCI) packet. Here, the communication system may be a Gigabit-capable Passive Optical Network (GPON) system. The communication server 110 may broadcast an image of software to the plurality of terminals (terminal 1, terminal 2, and terminal 3) 120 so that the image of new software may be applied to the terminals (terminal 1, terminal 2, and terminal 3) 120.

Here, an OMCI channel corresponds to an OMCI channel of the GPON system defined in a G984.4 standard, and indicates an interface for controlling the communication server 110 and the terminals (terminal 1, terminal 2, and terminal 3) 120. The OMCI channel may be set using a Physical Layer optical amplifier module (OAM) (PLOAM) between the communication server 110 and the terminals (terminal 1, terminal 2, and terminal 3) 120.

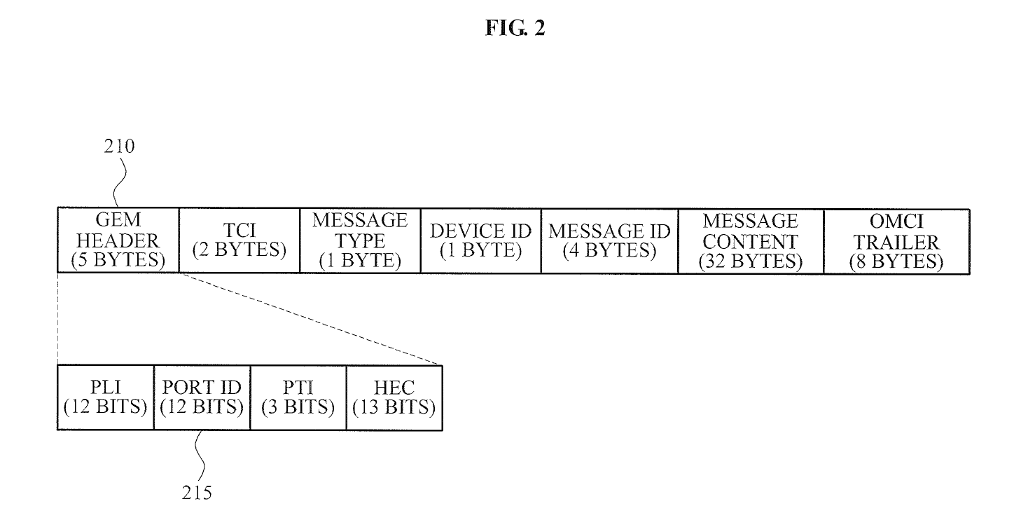

FIG. 2 is a diagram illustrating a format of the OMCI packet in the communication system of FIG. 1.

FIG. 2 shows a format of a packet that may be transmitted and received between an Optical Line Termination (OLT) and a terminal via the OMCI channel set in FIG. 1.

Referring to FIG. 2, a GPON Encapsulation Method (GEM) header 210 of the OMCI packet may consist of five bytes, and particularly, include a port identifier (ID) 215. Here, a header of the port ID 215 may indicate a unique number that is assigned to each corresponding terminal so that only a terminal having the same unique number as the unique number of the port ID 215 may receive the OMCI packet.

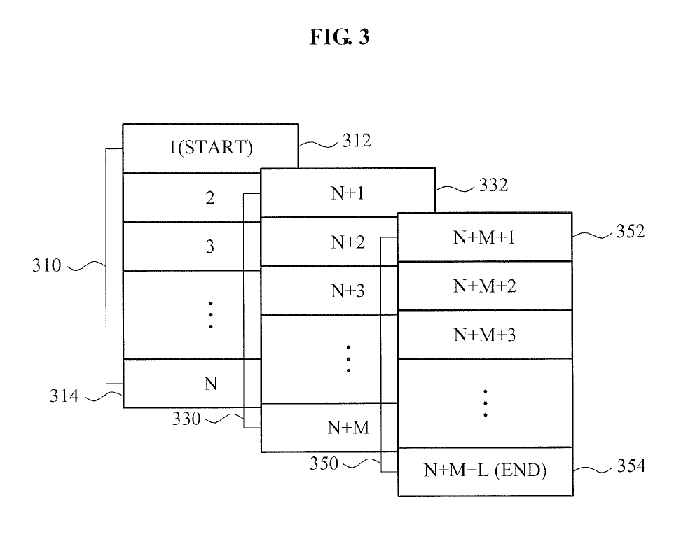

FIG. 3 is a diagram illustrating an image of software transmitted from a server according to an embodiment of the present invention.

Referring to FIG. 3, the image of software may be divided into sections, for example, a section 310 including 1 (START) 312 through N 314, a section 330 including N+1 332 through N+M, and a section 350 including N+M+1 352 through N+M+L (END) 354. Each of the sections 310, 330, and 350 may include 32 bytes corresponding to a maximum size of the OMCI packet.

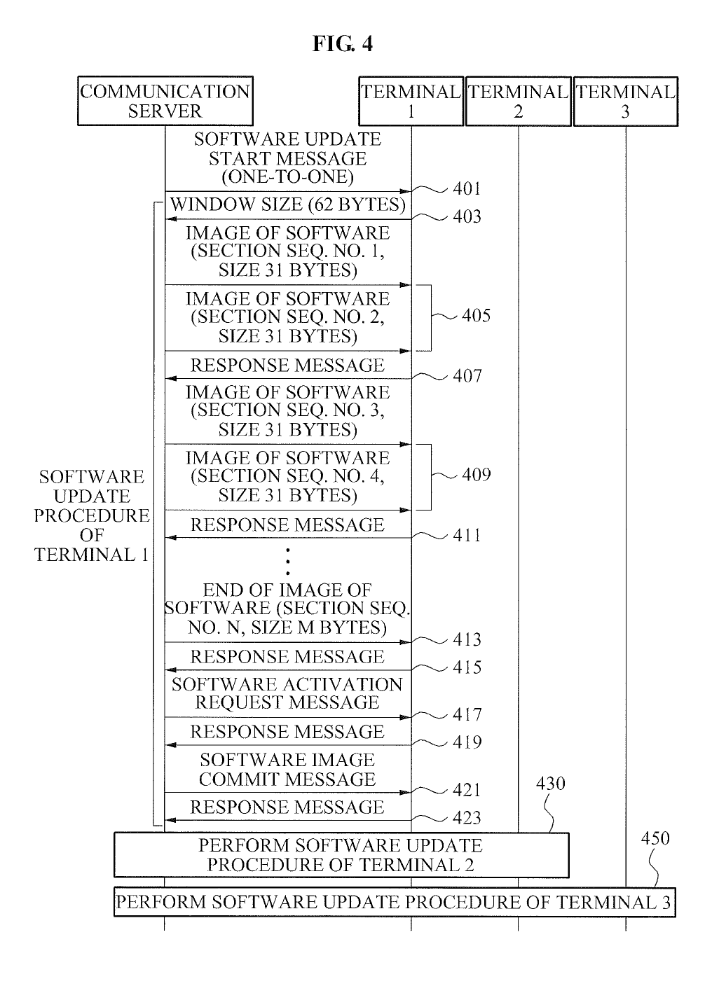

FIG. 4 is a diagram illustrating a process of performing a software update procedure in a one-to-one structure according to an embodiment of the present invention.

Referring to FIG. 4, when performing the software update procedure with respect to three terminals, for example, a terminal 1, a terminal 2, and a terminal 3, using a one-to-one structure, a communication server may transmit a software update start message to the terminal 1 in operation 401.

In operation 403, the terminal 1 receiving the software update start message may transmit a size of a window of the terminal 1, for example, 62 bytes to the communication server. The communication server receiving the window size of the terminal 1 may set an image of software, as shown in FIG. 3, to suit the received window size of the terminal 1.

For example, when the window size of the terminal 1 is 62 bytes, the communication server may prepare the image of software to be in sections having a size of 62 bytes. However, each section may not exceed 32 bytes that is a maximum size of an OMCI packet. Therefore, in this case, the image of software may be divided into sections where each single section has a size of 31 bytes, which may be sequentially transmitted.

The software update start message may be transmitted in the one-to-one structure between the communication server and the terminal 1, and may include a size of the image of software.

The term “image of software” used herein denotes firmware as is known to those skilled in the art. For example, the image of software may be an operating system (OS) program or other various application programs installed in a terminal. Also, the term “software” used herein may be used as a meaning that includes firmware.

The term “window” used herein corresponds to a terminology that is used in association with firmware and denotes a size of a section that may be transmitted and received between a server and a terminal without an acknowledgement (ACK) signal. For example, the window may correspond to the section 310 of FIG. 3 from 1 (START) 312 to N 314.

In operation 405, the communication server may sequentially contain, in the OMCI packet, sections constituting the image of software and thereby transmit the OMCI packet to the terminal 1.

When the terminal 1 receives a final window of a single section, for example, N 314 of FIG. 3, the terminal 1 may determine whether the received image of software is normal to thereby transmit a response message to the communication server in operation 407. In operations 409 and 411, the communication server may continuously transmit, to the terminal 1, sections constituting the image of software, and receive a response message from the terminal 1.

When the terminal 1 receives, from the communication server, an end of the image of software, for example, N+M+L (END) 354 of FIG. 3 in operation 413, the terminal 1 may transmit, to the communication server, a response message regarding whether the end of the image of software is normally received in operation 415.

In operation 417, the communication server may transmit a software activation request message to the terminal 1. In response thereto, the terminal 1 may transmit a response message to the communication server 110 in operation 419.

The communication server may transmit a software image commit message to the terminal 1 in operation 421, and may receive a response message from the terminal 1 in operation 423 to thereby terminate updating of software with respect to the terminal 1.

In operations 430 and 450, the same software update procedure performed with respect to the terminal 1 may be repeated with respect to the terminal 2 and the terminal 3.

In the aforementioned software update procedure with respect to three terminals, the communication server and the terminals may transmit and receive the OMCI packet in the one-to-one structure. Accordingly, in a GPON system accessible by a maximum of 64 terminals, it may take great amount of time to update software installed in the 64 terminals.

Hereinafter, a method of performing a software update procedure in a one-to-many structure according to an embodiment of the present invention will be described with reference to FIGS. 1 through 3, and FIG. 5.

Prior to describing the method of performing the software update procedure in the one-to-many structure, instead of using a unique number assigned to each of terminals, a particular number, for example, a predetermined number “4094” may be assigned to a header of a port ID so that all the terminals may perform reception. The above scheme corresponds to only an OMCI packet transmitted from a communication server to a terminal. In the case of an OMCI packet transmitted from the terminal to the communication server, a unique number assigned to the terminal may be used.

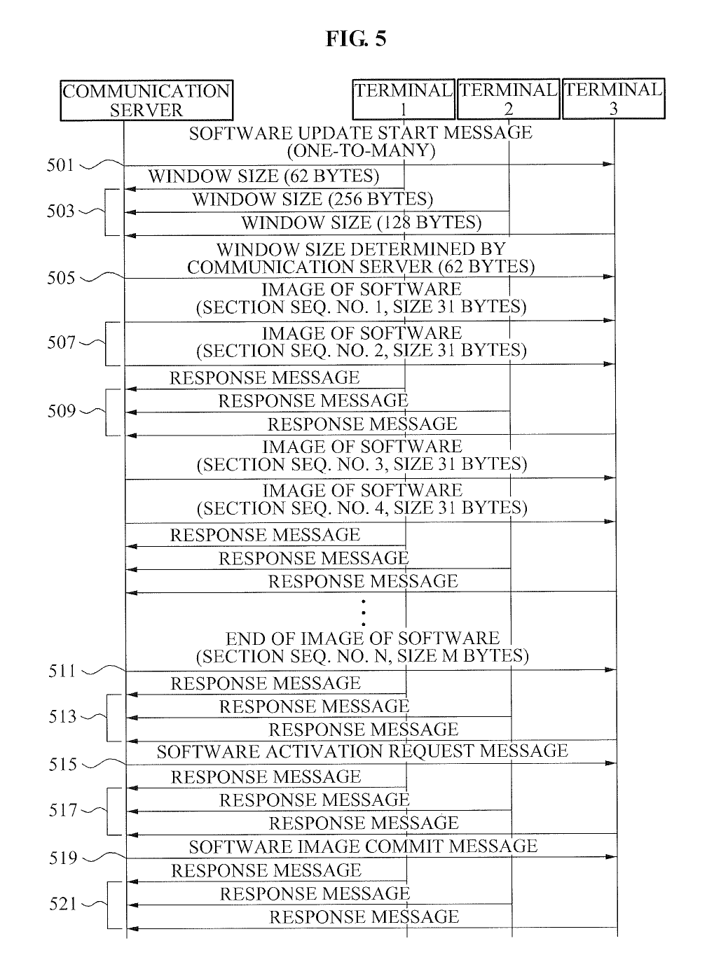

FIG. 5 is a diagram illustrating a process of performing a software update procedure in a one-to-many structure in order to simultaneously update software installed in a plurality of terminals between a communication server and the plurality of terminals in a communication system according to an embodiment of the present invention.

Referring to FIG. 5, in operation 501, the communication server may transmit a software update start message to all the terminals by assigning “4094” to a header of a port ID.

The software update start message may include information regarding a size of an image of software and a version of the software to be transmitted by the communication server.

Each of the terminals receiving the software update start message may set an update message based on the software update start message.

For example, when the version of the image of software is more recent than a version of the image of software installed in a corresponding terminal, the terminal may set, as the update message, a message indicating a size of a window of the terminal to thereby transmit the update message to the communication server.

Conversely, when the version of the image of software is the same to or older than the version of the image of software installed in the corresponding terminal, the terminal may set a failure message as the update message to thereby transmit the update message to the communication server.

The communication server may be aware of a total number of terminals accessing a GPON system. Therefore, when a number of response messages is equal to the total number of terminals, the communication server may select a smallest window size from window sizes of terminals that desire a software update, included in the received update message, and may transmit a window size message to all the terminals in operation 505.

A total number of terminals having software to be updated may be determined based on a number of success messages and failure messages received.

The communication server may prepare the image of software to suit the selected window size as shown in FIG. 3. In operation 507, the communication server may transmit, to all the terminals, the image of software sequentially from a first section.

In operation 509, all the terminals receiving a last OMCI packet of each section may transmit a response message to the communication server in order to determine whether a corresponding image section is normally received. When the corresponding image section is determined to be normally received based on the response message, the communication server may continuously transmit remaining sections constituting the image of software to all the terminals.

In operation 511, the communication server may transmit, to all the terminals, a message reporting an end of the image of software. In operation 513, the communication server may receive a response message from each of the terminals.

After transmitting the image of software to all the terminals, the communication server may transmit, to all the terminals, a software activation request message for an application of new software in operation 515. In response thereto, all the terminals may transmit a response message to the communication server in operation 517. The communication server may transmit a software image commit message, to all the terminals in operation 519, and receive a response message from the terminals in operation 521.

As described above, the communication server may effectively update the image of software by transmitting the image of software to all the terminals only once. Also, a method of simultaneously updating software installed in a plurality of terminals in a communication system may be applicable to all communication systems using a control channel, as well as a GPON system.

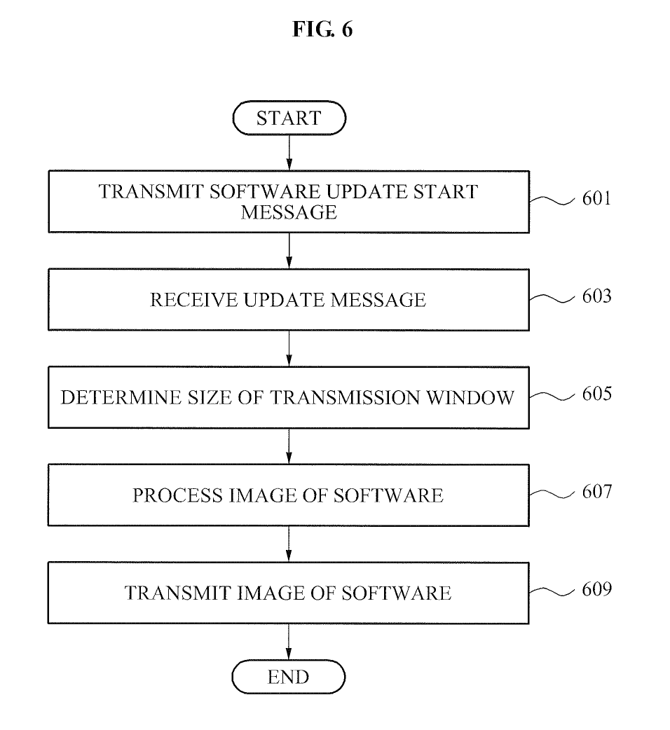

FIG. 6 is a flowchart illustrating a method of controlling a server to simultaneously update software installed in a plurality of terminals in a communication system according to an embodiment of the present invention.

In operation 601, the server may transmit a software update start message to the plurality of terminals.

In operation 601, the server may transmit the software update start message by assigning a predetermined number to a header of a port ID of a packet to be transmitted to the plurality of terminals. Also, the server may transmit the software update start message using a broadcasting scheme by assigning a particular number, for example, “4094” to the header of the port ID, instead of using a unique number assigned to each of the terminals, so that all the terminals may perform reception.

The software update start message may include information regarding a size of an image of software and a version of the image of software, which is provided from the communication server to the plurality of terminals.

The term “update” used herein may be similar to “upgrade” and thus indicates a new version of a particular piece of software in comparison to software currently installed in a user terminal.

In operation 603, the server may receive an update message from each of the terminals receiving the software update start message. The update message may correspond to at least one of a failure message and a message indicating a size of a window of a corresponding terminal.

When a terminal having software to be updated exists among the plurality of terminals receiving the software update start message, the corresponding terminal may transmit, to the server, the message indicating the window size of the terminal. When a version of software installed in a current terminal is more recent than a version of software provided by the server, the corresponding terminal may not need a software update and thus may transmit the failure message informing that the terminal will not update the software installed in the terminal.

To verify a version of software installed in each of the terminals, the server may include, in the software update start message, for example, an identifier indicating a type and a version of software to be updated.

Accordingly, each of the terminals receiving the software update start message may compare a type and a version of software installed in the corresponding terminal with the type and the version of software included in the software update start message to thereby determine whether to update software.

In operation 605, the server may determine a size of a transmission window based on the received update message.

The size of the transmission window may be determined as follows:

The update message received by the server from each of the terminals may include a size of a window of each corresponding terminal. Accordingly, the server may determine, as the size of the transmission window, a smallest window size among window sizes of the terminals. To determine the size of the transmission window, a scheme of selecting a window size corresponding to an average window size of the terminals that desire a software update may be considered.

The size of the transmission window indicates a window size selected from the window sizes of the terminals to be used as a transmission unit by the server. For example, 62 bytes of the terminal 1, 256 bytes of the terminal 2, and 128 bytes of the terminal 3, received from the terminal 1, the terminal 2, and the terminal 3 to the communication server in operation 503 of FIG. 5, indicate the window size of the terminal 1, the window size of the terminal 2, and the window size of the terminal 3, respectively. 62 bytes finally determined by the communication server in operation 505 may correspond to the size of the transmission window.

In this instance, the server may be aware of a total number of terminals accessing a GPON system. For example, a total number of terminals having software to be updated may be determined by counting a number of messages indicating the window size of the corresponding terminal, or by counting a number of failure messages.

To inform each of the terminals about the determined size of the transmission window, the server may transmit the message indicating the size of the transmission window.

In operation 607, the server may process an image of software to be transmitted to the plurality of terminals based on the determined size of the transmission window. In this instance, as described above with reference to FIGS. 3 and 4, the server may process the image of software so that a size of a single section may not exceed 32 bytes, that is, a maximum size of an OMCI packet to suit the size of the transmission window.

In operation 609, the image of software processed for each section using the OMCI packet may be transmitted to the plurality of terminals in operation 609. In this instance, the server may transmit a software activation request message for an application of the image of terminal software to the plurality of terminals, and may activate software with respect to the plurality of terminals having requesting the software update.

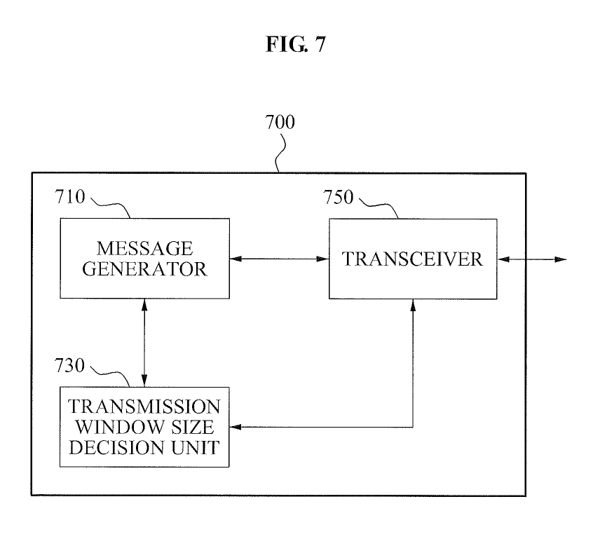

FIG. 7 is a block diagram illustrating a configuration of a server 700 to simultaneously update software installed in a plurality of terminals in a communication system according to an embodiment of the present invention. Referring to FIG. 7, the server 700 may include a message generator 710 and a transmission window size decision unit 730. The server 700 may further include a transceiver 750.

Here, the server 700 denotes a device that may provide software or firmware required by various types of terminals via a wired network including a control channel, for example, an OS program and an application program.

The message generator 710 may generate at least one message of a software update start message that is transmitted to the plurality of terminals, and indicates a start of updating with respect to the plurality of terminals, a message that is transmitted to the plurality of terminals, and indicates a size of a transmission window, a message that indicates an end of an image of software installed in the plurality of terminals, a software activation request message that is transmitted to the plurality of terminals for an application of the image of software, and a software image commit message that indicates a termination of update with respect to the plurality of terminals.

Here, the above message may be generated using the same scheme or have the same form. Each of the messages may be determined to have a different name based on information included in a corresponding message.

The transmission window size decision unit 730 may determine the size of the transmission window to be transmitted to the plurality of terminals. In this instance, the size of the transmission window may be determined by selecting a smallest window size from window sizes of terminals having requested the software update, included in the update message.

The transceiver 750 may transmit the generated at least one message to the plurality of terminals, and may receive, from each of the terminals, a response message including the update message.

The transceiver 750 may transmit the software update start message by assigning a predetermined number to a header of a port ID of a packet to be transmitted to the plurality of terminals. Instead of using a unique number assigned to each of the terminals, the transceiver 750 may transmit a message using a broadcasting scheme by assigning a particular number, for example, “4094” to the header of the port ID.

The software update start message may include information regarding a size of an image of software and a version of the image of software.

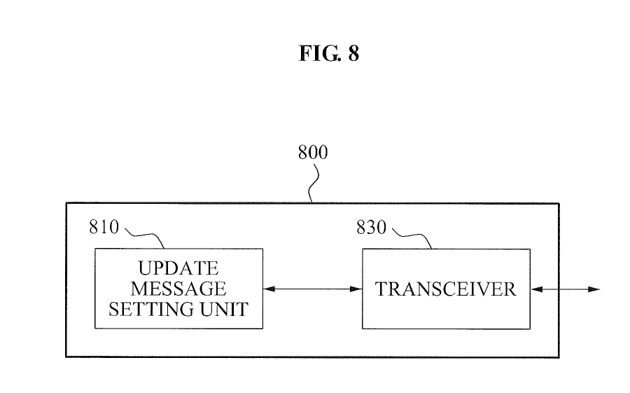

FIG. 8 is a block diagram illustrating a configuration of a terminal 800 to simultaneously update software installed in a plurality of terminals in a communication system according to an embodiment of the present invention. Referring to FIG. 8, the terminal 800 may include an update message setting unit 810 and a transceiver 830.

Here, the terminal 800 may denote a device that may have software to be updated via an Internet Protocol Television (IPTV) set-top box, a Voice over Internet Protocol (VoIP) gateway, a home gateway, and a wired network including a control channel, or a device may enable an installation of software via the control channel.

The update message setting unit 810 may set an update message based on the software update start message.

In this instance, when a version of an image of software is more recent than a version of software installed in a corresponding terminal, the update message setting unit 810 may set, as an update message, a message indicating a size of a window of the terminal. When a version of the image of software is the same or older than the version of the image of software installed in the terminal, the update message setting unit 810 may set a failure message as the update message.

The transceiver 830 may receive the software update start message from the server, and transmit the update message to the server.

Descriptions related to the server 700 and the terminal 800 not made above with reference to FIGS. 7 and 8 may refer to descriptions made above with reference to FIGS. 1 through 6.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A method of controlling a server to simultaneously update software installed in a plurality of terminals in a communication system, the method comprising:
receiving an update message from each of the terminals;
determining a size of a transmission window based on the update message;
processing an image of software to be transmitted to the plurality of terminals, based on the size of the transmission window; and
transmitting the image of software to the plurality of terminals.

2. The method of claim 1, further comprising:
transmitting a software update start message to the plurality of terminals.

3. The method of claim 2, wherein the transmitting of the software update start message comprises transmitting the software update start message by assigning a predetermined number to a port identifier header of a packet to be transmitted to the plurality of terminals.

4. The method of claim 2, wherein the software update start message includes information regarding a size of the image of software and a version of the image of software.

5. The method of claim 1, wherein the determining comprises determining, as the size of the transmission window, a smallest window size among window sizes of terminals that desire a software update, included in the update message.

6. The method of claim 1, wherein:
the update message corresponds to at least one of a failure message and a message indicating a size of a window of a corresponding terminal, and
the method further comprises determining a number of terminals having software to be updated based on the update message.

7. The method of claim 1, further comprising:
transmitting, to the plurality of terminals, a message indicating the size of the transmission window.

8. The method of claim 1, further comprising:
transmitting, to the plurality of terminals, a software activation request message for an application of the image of software.

9. A method of controlling a terminal to simultaneously update software installed in a plurality of terminals in a communication system, the method comprising:
receiving a software update start message; and
setting an update message based on the software update start message.

10. The method of claim 9, wherein the software update start message includes information regarding a size of an image of software and a version of the image of software.

11. The method of claim 9, wherein:
the software update start message includes information regarding a size of an image of software and a version of the image of software, and
when the version of the image of software is more recent than a version of software installed in a corresponding terminal, the setting comprises setting, as the update message, a message indicating a size of a window of the corresponding terminal to thereby transmit the update message.

12. The method of claim 11, wherein, when the version of the image of software is the same or older than the version of software installed in the corresponding terminal, the setting comprises setting a failure message as the update message to thereby transmit the update message.

13. A server to simultaneously update software installed in a plurality of terminals in a communication system, the server comprising:
a message generator to generate at least one message of a software update start message that is transmitted to the plurality of terminals, and indicates a start of update with respect to the plurality of terminals, a message that is transmitted to the plurality of terminals, and indicates a size of a transmission window, a message that indicates an end of an image of software installed in the plurality of terminals, a software activation request message that is transmitted to the plurality of terminals for an application of the image of software, and a software image commit message that indicates a termination of updating with respect to the plurality of terminals; and
a transmission window size decision unit to determine the size of the transmission window to be transmitted to the plurality of terminals.

14. The server of claim 13, further comprising:
a transceiver to transmit the generated at least one message to the plurality of terminals, and to receive an update message from each of the terminals.

15. The server of claim 14, wherein the transceiver transmits the at least one message by assigning a predetermined number to a header of a packet to be transmitted to the plurality of terminals.

16. The server of claim 13, wherein the software update start message includes information about a size of the image of software and a version of the image of software.

17. The server of claim 14, wherein the transmission window size decision unit determines the size of the transmission window based on the update message.

18. The server of claim 17, wherein the transmission window size decision unit determines, as the size of the transmission window, a smallest window size among window sizes of terminals that desire a software update, included in the update message.

19. A terminal to simultaneously update software installed in a plurality of terminals in a communication system, the terminal comprising:
a transceiver to receive, from a server, a message including a software update start message, and to transmit an update message to the server; and
an update message setting unit to set the update message based on the software update start message.

20. The terminal of claim 19, wherein:
the software update start message includes information regarding a size of an image of software, provided from the server to the terminal, and a version of the image of software, and
when the version of the image of software is more recent than a version of software installed in the terminal, the update message setting unit sets, as the update message, a message indicating a size of a window of the terminal to thereby transmit the update message.
